(19) United States
(12) Patent Application Publication
(10) Pub. No.: US 2011/0156971 A1
(43) Pub. Date: Jun. 30, 2011

(54) WIDE BAND ANTENNA

(75) Inventors: CHIH-YUAN YANG, Tu-Cheng (TW); MING-LIANG YANG, Tu-Cheng (TW); WEN-CHIN OU, Tu-Cheng (TW)

(73) Assignee: HON HAI PRECISION INDUSTRY CO., LTD., Tu-Cheng (TW)

(21) Appl. No.: 12/873,204

(22) Filed: Aug. 31, 2010

(30) Foreign Application Priority Data
Dec. 25, 2009 (CN) 200910312288.5

(51) Int. Cl. H01Q 1/36

(52) U.S. Cl. 343/729

(57) ABSTRACT

A wide band antenna includes a radiation element, a ground surface, a dielectric element, and a RF connector. The radiation element is connected to the ground element and includes a first radiation part and a second radiation part. The first radiation part includes at least one slit for obtaining low frequency-bands. The second radiation part is for obtaining high frequency-bands. The dielectric element supports and spaces the radiation element and the ground element. The RF connector is connected to the second part of the antenna and the ground element.

### BACKGROUND

1. Technical Field

The present disclosure relates to a wide band antenna and, particularly, to a wide band antenna for mobile communication.

2. Description of Related Art

Currently, services for wireless communication have changed from narrow band communication services to wide band communication services, such as what is used to provide access to the Internet. Due to the need to develop an integrated system capable of providing multiple services through a single terminal, the antennas of wireless communication systems should be multi-functional.

### BRIEF DESCRIPTION OF THE DRAWINGS

The components of the drawings are not necessarily drawn to scale, the emphasis instead being placed upon clearly illustrating the principles of the wide band antenna. Moreover, in the drawings, like reference numerals designate corresponding parts throughout several views.

FIG. 1 is an isometric view of a wide band antenna for mobile communication in accordance with one embodiment including a folded portion forming a radiation element of the antenna.

FIG. 2 is a schematic unfolded view of the radiation element of FIG. 1 with folding lines indicated by dashed lines.

FIG. 3 is a graph showing electrical characteristics of the antenna of FIG. 1

### DETAILED DESCRIPTION

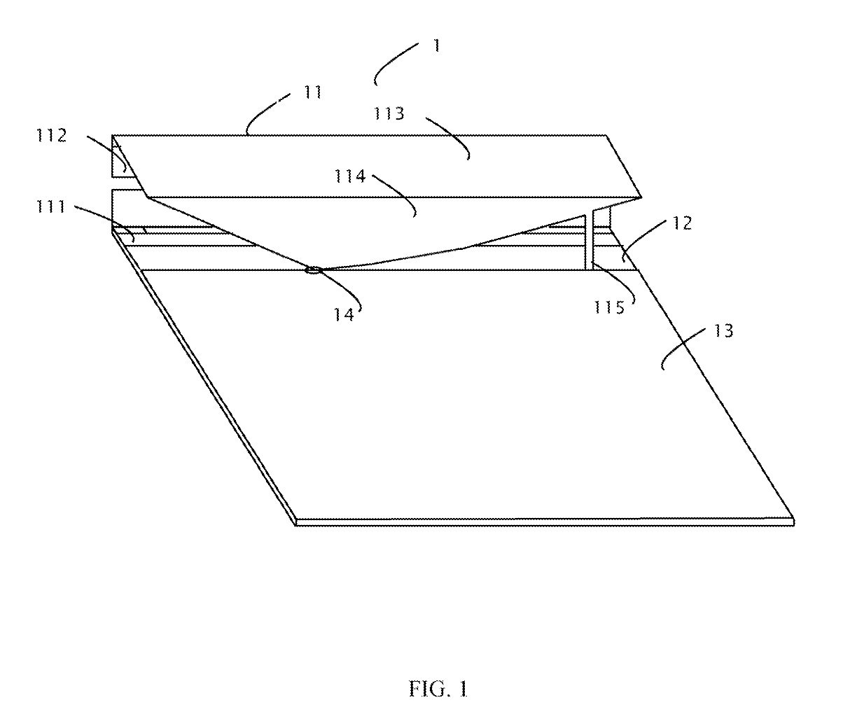

FIG. 1 is an isometric view of a wide band antenna 1 for mobile communication in accordance with one embodiment. The antenna 1 is used for receiving radio frequency (RF) signals and radiating corresponding radio waves. The antenna 1 includes a radiation element 11, a dielectric element 12, a ground surface 13, and a RF connector 14. The radiation element 11 and the ground surface 13 are supported and spaced by the dielectric element 12. The radiation element 11 and the ground surface 13 are conductive. The RF connector 14 is connected to a RF receiver (not shown) for transmitting RF signals to the radiation element 11.

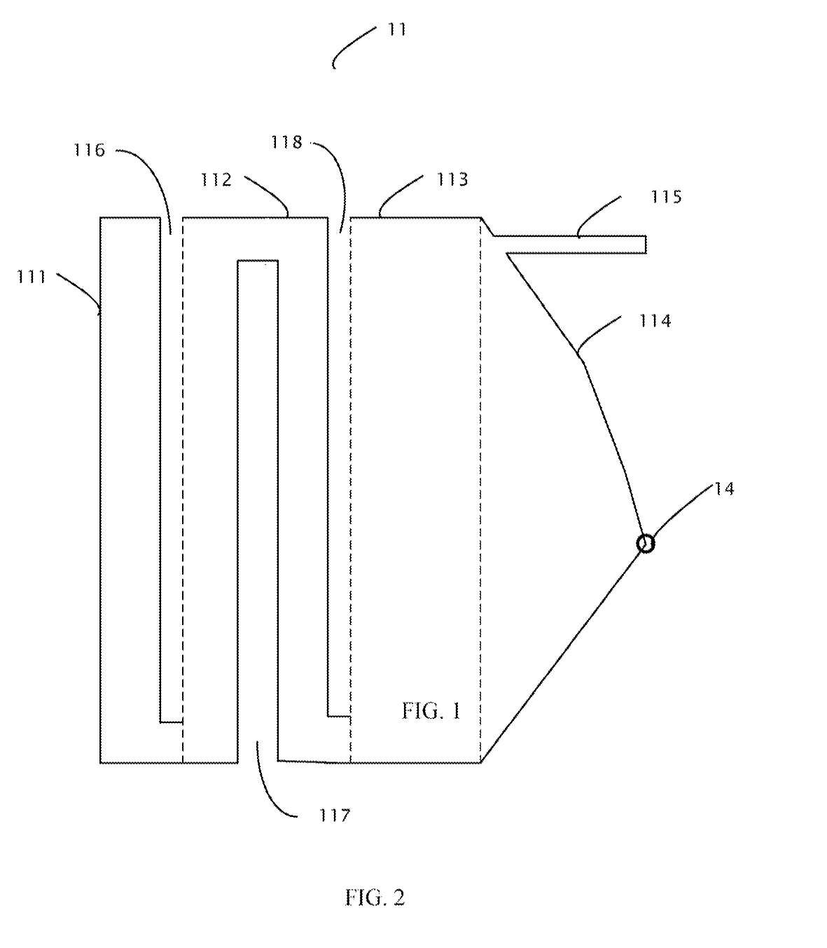

The radiation element 11 is folded from a planar conductor. The planar conductor is shown in FIG. 2. For decreasing the size of the antenna 1, the radiation element 11 is folded to include four parts: a first radiation part 111, a second radiation part 112 substantially perpendicular to the first radiation part 111, a third radiation part 113 opposing the first radiation part 111, and a fourth radiation part 114 opposing the second radiation part 112.

The first radiation part 111 is supported by the dielectric element 12 and spaced from the ground surface 13 by the dielectric element 12. The first radiation part 111 is substantially rectangular. The first radiation part 111 includes a first slit 116. The first slit 116 is defined adjacent to the second radiation part 112. The second radiation part 112 is also substantially rectangular. The second radiation part 112 includes a second slit 117 and a third slit 118. The second slit 117 is defined at the middle of the second radiation part 112. The third slit 118 is defined adjacent to the third radiation part 113. The first slit 116 and the second slit 117 include open ends at opposite sides of the radiation element 11. The third slit 118 includes an open end formed at the same side where the open end of the first slit 116 is formed. The third radiation part 113 is also substantially rectangular. The fourth radiation part 114 is substantially triangular. The RF connector 14 is connected to a vertex of the fourth radiation part 114. A ground connector 115 extends from one side of the fourth radiation part 114 and is connected to the ground surface 13.

The first slit 116, the second slit 117, and the third slit 118 are used for increasing the radiation path of the antenna 1 without increasing the length of the antenna 1. Because the frequency of the antenna 1 is inversely proportional to the length of the radiation path of the antenna 1, a low frequency band can be obtained by use of the slits 116, 117, 118. The substantially triangle shaped of the fourth radiation part 114 enables communication using a high band frequency. Thus, the wide band antenna can be realized.

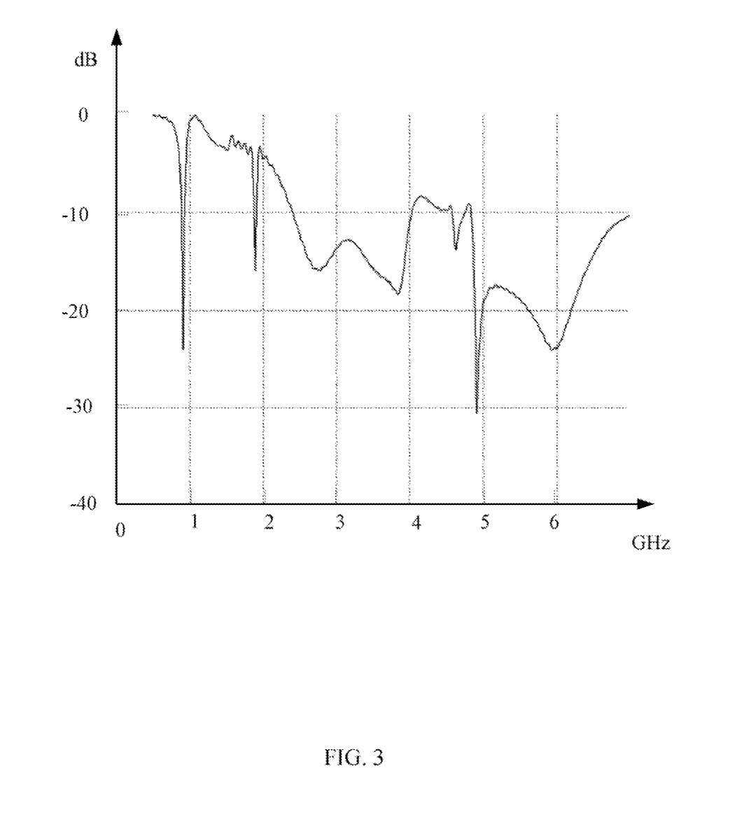

FIG. 3 is a graph showing return losses of the antenna 1 at different frequencies. It can be seen in the graph that the return loss of the antenna is less than −10 db, when the frequency-band of the antenna 1 includes 0.9 GHz, 1.8 GHz, 2.3-4 GHz, and 4.9-5.8 GHz. Thus, it is established that the antenna 1 can be an effective wide band antenna.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A wide band antenna, comprising:
a ground element;
a radiation element connected to the ground element and comprising a first radiation part and a second radiation part, the first radiation part comprising at least one slit for obtaining low frequency-bands, the second radiation part being configured for obtaining high frequency-bands;
a dielectric element for supporting and spacing the radiation element and the ground element; and
a radio frequency (RF) connector connected to the second radiation part of the antenna and the ground element.

2. The wide band antenna as described in claim 1, wherein the first radiation part and the second radiation part of the antenna are substantially perpendicular to each other.

3. The wide band antenna as described in claim 1, wherein the first radiation part is folded to include three parts: a first part, a second part substantially perpendicular to the first part and opposing the second part, and a third part opposing the first part.

4. The wide band antenna as described in claim 3, wherein the first part of the first radiation part is supported by the dielectric element.

5. The wide band antenna as described in claim 3, wherein the at least one slit of the first radiation part comprises a first slit, a second slit, and a third slit, the first slit is defined adjacent to the second part of the first radiation part, the second slit is defined at the middle of the second part of the first radiation part, the third slit is defined adjacent to the third part of the first radiation part.

6. The wide band antenna as described in claim 5, wherein the first slit and the second slit comprise open ends at opposite sides of the first radiation part, the third slit includes an open end formed at the same side where the open end of the first slit is formed.

7. The wide band antenna as described in claim 1, wherein the second radiation part of the antenna is substantially triangular.

8. The wide band antenna as described in claim 7, wherein the RF connector is connected to a vertex of the second radiation part.
